(19) United States
(12) Patent Application Publication
(10) Pub. No.: US 2013/0091906 A1
(43) Pub. Date: Apr. 18, 2013

(54) Zipper Lock

(71) Applicant: SINOX LOCK (KUNSHAN) CO., LTD., Kunshan City (CN)

(72) Inventor: Mao-Yi Chen, Kuanshan City (CN)

(73) Assignee: SINOX LOCK (KUNSHAN) CO., LTD., Kunshan City (CN)

(21) Appl. No.: 13/649,331

(22) Filed: Oct. 11, 2012

Related U.S. Application Data
(60) Provisional application No. 61/546,467, filed on Oct. 12, 2011.

(51) Int. Cl. E05B 65/52

(52) U.S. Cl. 70/68

(57) ABSTRACT

A zipper lock contains a body, a locking cylinder, and a releasing element. The body has a locking mechanism disposed therein and at least one zipper locked thereon. The locking cylinder is defined on the body and is controlled by a key so as to change toward a lock position and a unlock position. The releasing element is mounted on the body for matching with the locking cylinder. Thereby, when the locking cylinder is changed toward the unlock position, it is moved toward a release position with the releasing element so as to remove the at least one zipper from the body.

### FIELD OF THE INVENTION

The present invention relates to a zipper lock which is fixed on a bag with zippers, and more particularly to zipper lock having a locking mechanism so as to unlock and lock at least one zipper.

### BACKGROUND OF THE INVENTION

A conventional zipper lock contains a body and a locking mechanism or a combination lock mechanism defined in the body. However, the zipper lock also contains at least one releasing element (such as a press button, a push switch, or a rotary knob) so when the zipper lock is unlocked by ways of a key or a password check of the combination lock, the releasing element is further applied to unlock the zipper from the zipper lock, thus having complicated structure and using inconvenience.

The present invention has arisen to mitigate and/or obviate the afore-described disadvantages.

### SUMMARY OF THE INVENTION

The primary object of the present invention is to provide a zipper lock which has simplified structure and a small size.

To obtain the above objective, a zipper lock provided by a preferred embodiment of the present invention contains: a body, a locking cylinder, and a releasing element.

The body has a locking mechanism disposed therein and at least one zipper locked thereon. The locking cylinder is defined on the body and is controlled by a key so as to change toward a lock position and a unlock position. The releasing element is mounted on the body for matching with the locking cylinder. Thereby, when the locking cylinder is changed toward the unlock position, it is moved toward a release position with the releasing element so as to remove the at least one zipper from the body.

A zipper lock provided by another preferred embodiment of the present invention contains: a body, a locking cylinder, and a releasing element.

The body has a locking mechanism disposed therein and at least one zipper locked thereon. The locking cylinder is defined on the body and is controlled by a key so as to change toward a lock position and a unlock position. The releasing element is mounted on the body for matching with the locking cylinder, such that when the locking cylinder is changed toward the unlock position, the locking cylinder is moved toward a release position with the releasing element so that the at least one zipper is removed, and the locking cylinder is moved toward a fastening position so that the at least one zipper is not remove from the body.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1A is a plan view showing the assembly of a zipper lock according to a first embodiment of the present invention.

FIG. 1B is a plan view showing the operation of the zipper lock according to the first embodiment of the present invention.

FIG. 2A is a plan view showing the assembly and the operation of a zipper lock according to a second embodiment of the present invention.

FIG. 2B is another plan view showing the assembly and the operation of the zipper lock according to the second embodiment of the present invention.

FIG. 3A is a plan view showing the assembly and the operation of a zipper lock according to a third embodiment of the present invention.

FIG. 3B is another plan view showing the assembly and the operation of the zipper lock according to the third embodiment of the present invention.

FIG. 4 is a perspective view showing the assembly of a zipper lock according to a fourth embodiment of the present invention.

FIG. 5A is a plan view showing the operation of the zipper lock according to the fourth embodiment of the present invention.

FIG. 5B is another plan view showing the operation of the zipper lock according to the fourth embodiment of the present invention.

### DETAILED DESCRIPTION OF THE PREFERRED EMBODIMENTS

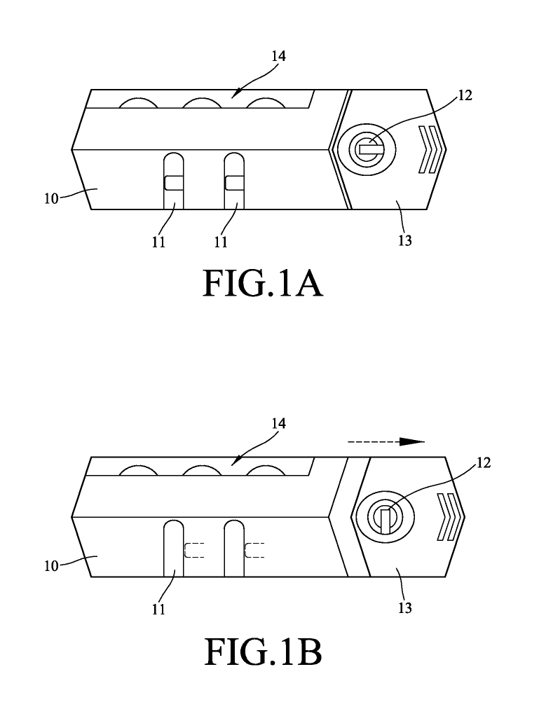

FIG. 1A is a plan view showing the assembly of a zipper lock according to a first embodiment of the present invention. FIG. 1B is a plan view showing the operation of the zipper lock according to the first embodiment of the present invention. The zipper lock comprises a locking mechanism disposed therein and a body 10 having at least one groove 11 for receiving at least one zipper (not shown). The body 10 also has a locking cylinder 12 defined thereon and controlled by a key so as to change toward a lock position (as shown in FIG. 1A) and a unlock position (as illustrated in FIG. 1B). The body 10 further has a releasing element 13 mounted thereon for matching with the locking cylinder 12.

The locking cylinder 12 is integrally formed with the releasing element 13 so that the locking cylinder 12 and the releasing element 13 operate together, such that when the locking cylinder 12 is changed toward the unlock position (as shown in FIG. 1B), it is pushed toward a release position with the releasing element 13 (as shown by an arrow direction in FIG. 1B) so as to unlock the at least one zipper, hence the at least one zipper in the at least one groove 11 of the body 10 is removed.

It is to be noted that the releasing element 13 is a slider for being pushed relative to the body 10.

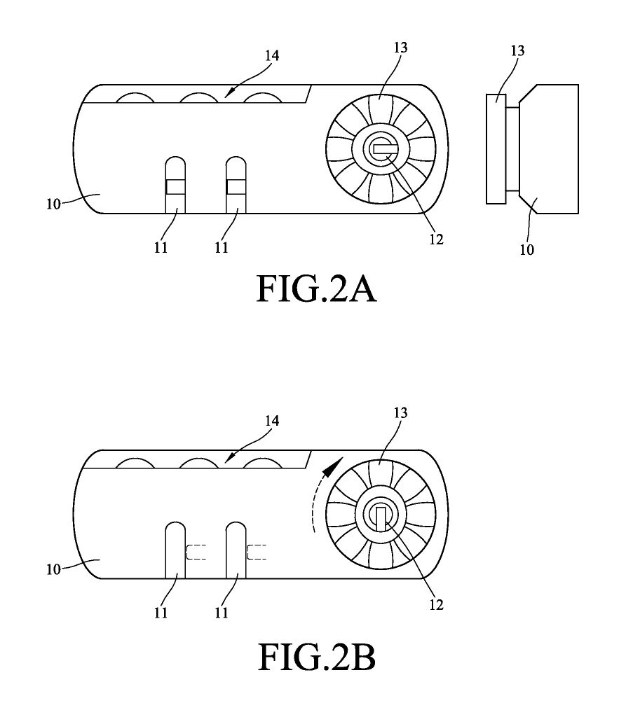

FIG. 2A is a plan view showing the assembly and the operation of a zipper lock according to a second embodiment of the present invention. FIG. 2B is another plan view showing the assembly and the operation of the zipper lock according to the second embodiment of the present invention.

The zipper lock comprises a releasing element 13, and the releasing element 13 is a rotating element for being rotated relative to a body 10, such that when a locking cylinder 12 is changed toward a unlock position (as shown in FIG. 2B), it is rotated toward a release position with the releasing element 13 (as illustrated by an arrow direction in FIG. 2B) so as to unlock at least one zipper, hence the at least one zipper in at least one groove 11 of the body 10 is removed.

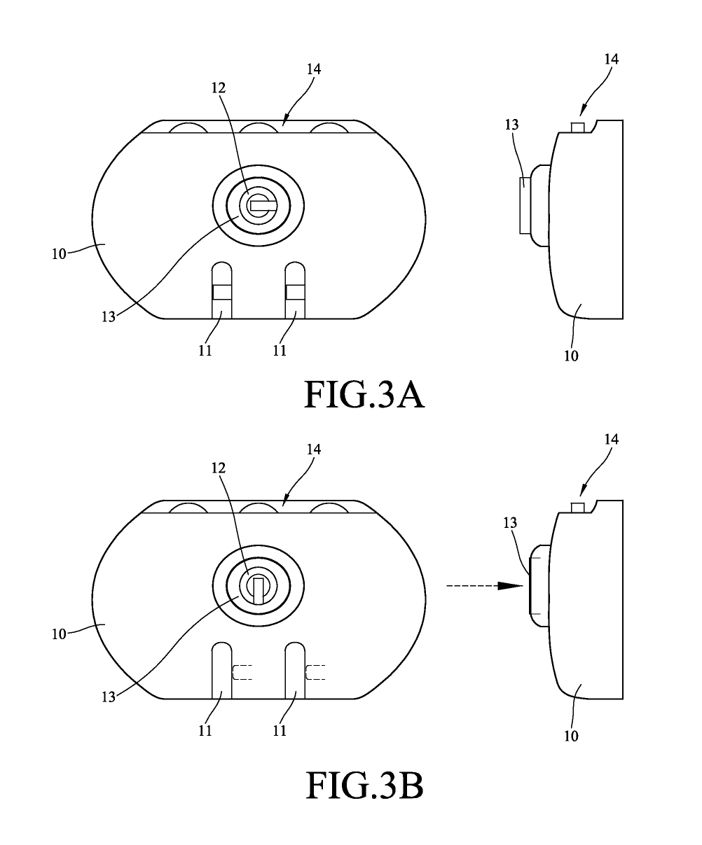

FIG. 3A is a plan view showing the assembly and the operation of a zipper lock according to a third embodiment of the present invention. FIG. 3B is another plan view showing the assembly and the operation of the zipper lock according to the third embodiment of the present invention. The zipper lock comprises a releasing element 13, and the releasing element 13 is a button element for being pressed relative to a body 10, such that when a locking cylinder 12 is changed toward a unlock position (as shown in FIG. 3B), it is pressed toward a release position with the releasing element 13 (as illustrated by an arrow direction in FIG. 3B) so as to unlock the zipper, hence at least one zipper of the zipper lock in at least one groove 11 of the body 10 is removed.

Thereby, the body 10 has the locking cylinder 12 which is controlled by the key to unlock or lock the at least one zipper. In addition, the body 10 further has a combination lock mechanism 14 so that the zipper lock is unlocked or locked by the key and by ways of a password check of a combination lock.

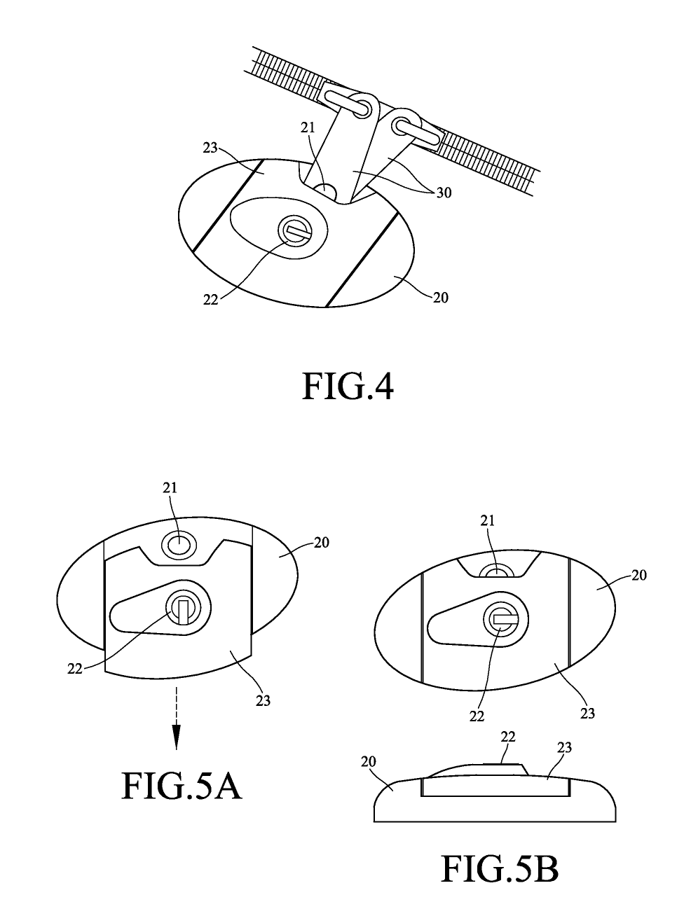

FIG. 4 is a perspective view showing the assembly of a zipper lock according to a fourth embodiment of the present invention. The zipper lock comprises a locking mechanism disposed therein and a body 20 having at least one locker 21 for locking at least one zipper 30 on the body 20. The body 20 has a locking cylinder 22 controlled by a key so as to change toward a lock position and a unlock position. The body 20 further has a releasing element 23 mounted thereon for matching with the locking cylinder 22.

FIG. 5A is a plan view showing the operation of the zipper lock according to the fourth embodiment of the present invention.

FIG. 5B is another plan view showing the operation of the zipper lock according to the fourth embodiment of the present invention.

It is to be noted that the releasing element 23 is a limiting element for limiting the at least one zipper 30 to be removed, such that when the locking cylinder 22 is controlled to change toward the unlock position, it is moved toward a release position (as shown in FIG. 5A) with the releasing element 23 and a fastening position (as illustrated in FIG. 5B), hence when the releasing element 23 is located at the release position, the at least one zipper 30 is removed from the body 20, and when the releasing element 23 is located at the fastening position, the at least one zipper 30 is stopped or interfered by the releasing element 23, so it does not remove from the body 20.

As shown in FIG. 5B, the releasing element 23 is a slider for being pushed relative to the body 20 or a rotating element for being rotated relative to the body 20.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A zipper lock comprises:
a body having a locking mechanism disposed therein and at least one zipper locked thereon;
a locking cylinder defined on the body and controlled by a key so as to change toward a lock position and a unlock position;
a releasing element mounted on the body for matching with the locking cylinder, such that when the locking cylinder is changed toward the unlock position, it is moved toward a release position with the releasing element so as to remove the at least one zipper from the body.

2. The zipper lock as claimed in claim 1, wherein the releasing element is a slider for being pushed relative to the body.

3. The zipper lock as claimed in claim 1, wherein the releasing element is a rotating element for being rotated relative to a body.

4. The zipper lock as claimed in claim 1, wherein the releasing element is a button element for being pressed relative to a body.

5. The zipper lock as claimed in claim 1, wherein the body further has a combination lock mechanism.

6. A zipper lock comprises:
a body having a locking mechanism disposed therein and at least one zipper locked thereon;
a locking cylinder defined on the body and controlled by a key so as to change toward a lock position and a unlock position;
a releasing element mounted on the body for matching with the locking cylinder, such that when the locking cylinder is changed toward the unlock position, the locking cylinder is moved toward a release position with the releasing element so that the at least one zipper is removed, and the locking cylinder is moved toward a fastening position so that the at least one zipper is not remove from the body.

7. The zipper lock as claimed in claim 6, wherein the releasing element is a slider for being pushed relative to the body.

8. The zipper lock as claimed in claim 6, wherein the releasing element is a rotating element for being rotated relative to a body.
